(19) United States
(12) Patent Application Publication
(10) Pub. No.: US 2020/0198847 A1
(43) Pub. Date: Jun. 25, 2020

(54) WATER VAPOR GUIDE COVER

(71) Applicant: SOUTH PLASTIC INDUSTRY CO., LTD., New Taipei City (TW)

(72) Inventor: Tong-Chang Wang, New Taipei City (TW)

(21) Appl. No.: 16/231,942

(22) Filed: Dec. 25, 2018

(51) Int. Cl. B65D 43/02; A47J 36/02

(52) U.S. Cl. CPC B65D 43/0208; A47J 36/027; B65D 2543/00101; B65D 2543/00796; B65D 2543/00731; B65D 2543/0074; B65D 2543/00351

(57) ABSTRACT

A water vapor guide cover includes: a cover body, including a convex top portion and edge portion, the convex top portion configured with a first peripheral wall, the first peripheral wall configured with guiding grooves, a bottom of the first peripheral wall extended outward with a groove, the groove in combination with the edge portion, further configured with a second peripheral wall, and the second peripheral wall configured with stoppers; and a box body, including a bottom portion and a third peripheral wall configured on the bottom portion, the third peripheral wall extended outward with a platform portion, inner, outer sides of the platform portion respectively configured with first, second step portions, the edge portion in contact with the platform portion, the groove positioned above the first step portion, each stopper pressed against the second step portion, and each guiding groove positioned above an inside of the box body.

### (a) TECHNICAL FIELD OF THE INVENTION

The present invention relates to a container, and more particularly to a water vapor guide cover having a water vapor leakage-proof effect.

### (b) DESCRIPTION OF THE PRIOR ART

Currently, all market-available microwave food containers are disposable such that the sealing effect is not good. Especially, internal vapor easily leaks from between the cover and box of the container, causing the box to be slippery and even sticky and not easy to be picked up, which is quite troublesome for users.

### SUMMARY OF THE INVENTION

In view of the above shortcomings, the present invention proposes a water vapor guide cover, including: a cover body, including a convex top portion and edge portion, a periphery of the convex top portion configured with a first peripheral wall bended downward, an inner side of the first peripheral wall configured with a plurality of guiding grooves at intervals, a bottom of the first peripheral wall extended outward with a groove, a top of another side of the groove in combination with the edge portion, another side of the edge portion further configured with a second peripheral wall bended downward, and an inner side of the second peripheral wall configured with a plurality of stoppers at intervals; and a box body, including a bottom portion and a third peripheral wall configured on a periphery of the bottom portion, a top surface of the third peripheral wall extended outward with a platform portion, an inner side and outer side of the platform portion respectively configured with a first step portion and second step portion, the edge portion of the cover body in contact with the platform portion, the groove positioned above the first step portion, each stopper pressed against the second step portion, and each guiding groove positioned above an inside of the box body.

### BRIEF DESCRIPTION OF THE DRAWINGS

FIG. 1 is a perspective view of the present invention;

FIG. 2 is an exploded view of the present invention; and

FIG. 3 is a partly cross-sectional view of the present invention, showing water vapor flow inside the present invention after a cover body is covered on a box body.

### DETAILED DESCRIPTION OF THE PREFERRED EMBODIMENTS

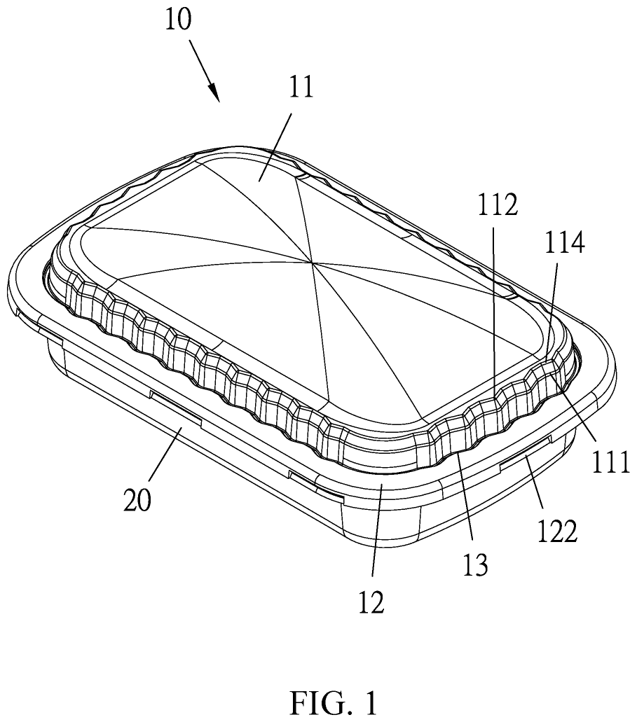

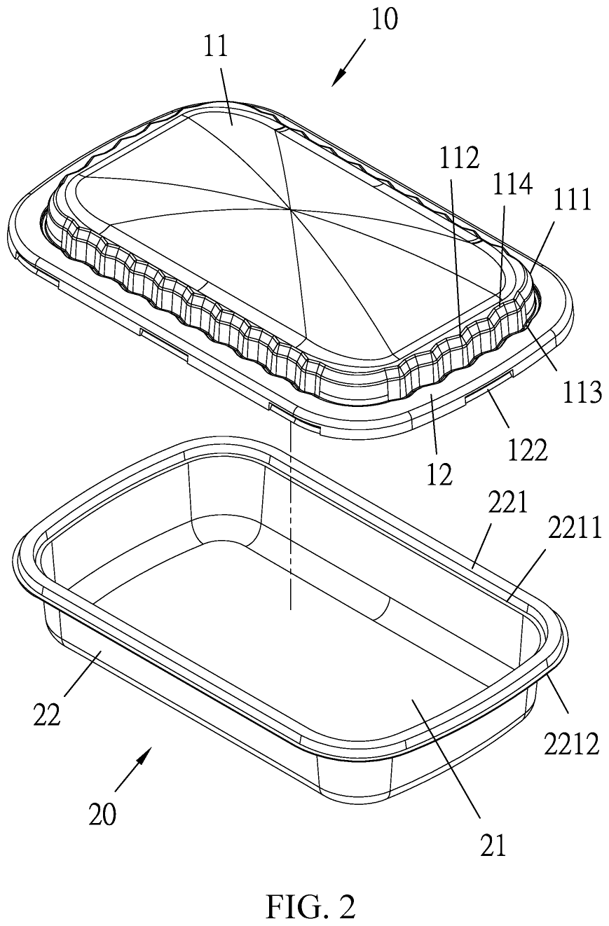

Referring to FIGS. 1 and 2, a water vapor guide cover of the present invention includes a cover body 10 including a convex top portion 11 and edge portion 12, where the periphery of the convex top portion 11 is configured with a first peripheral wall 111 bended downward, the inner side of the first peripheral wall 111 is provided with a plurality of guiding grooves 112 at intervals, the bottom of the first peripheral wall 111 is extended outward with a groove 113, the top of another side of which is in combination with the edge portion 12, another side of the edge portion 12 is further configured with a second peripheral wall 121 bended downward, and the inner side of the second peripheral wall 121 is configured with a plurality of stoppers 122 at intervals.

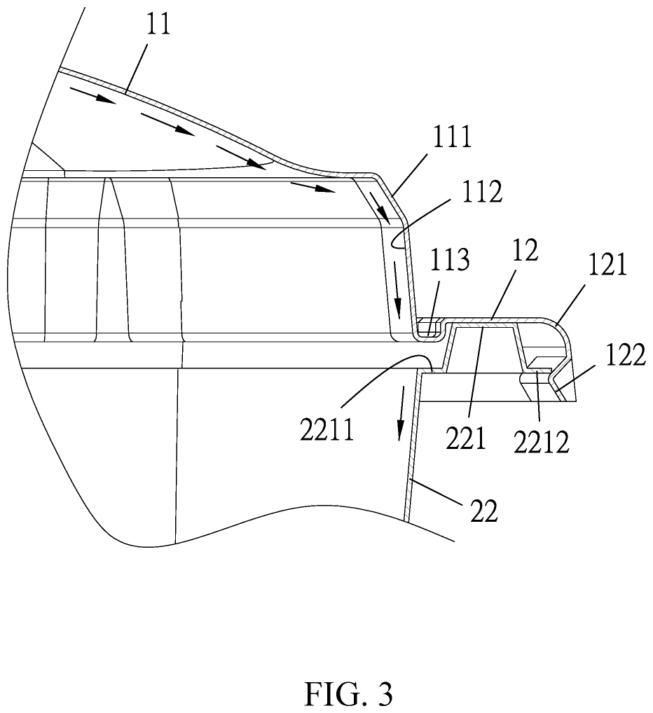

Referring to FIG. 3, the center of the top surface of the convex top portion 11 of the cover body 10 is higher than the first peripheral wall 111; the first peripheral wall 111 is configured with a plurality of convex arc portions 114 facing toward the inside of the cover body 10, and the guiding groove 112 is positioned between each two adjacent convex arc portions 114.

Referring to FIGS. 2 and 3, a box body 20 includes a bottom portion 21 and a third peripheral wall 22 configured on the periphery of the bottom portion 21, the top surface of the third peripheral wall 22 is extended outward with a platform portion 221, the inner side and outer side of the platform portion 221 are respectively extended with a first step portion 2211 and second step portion 2212.

Referring to FIG. 3 again, which shows a use manner of the water vapor guide cover of the present invention, microwave food is first placed inside the box body 20, and the cover body 10 is then covered on the box body 20 to allow the edge portion 12 of the cover body 10 to be in contact with the platform portion 221. At this time, the groove 113 is positioned above the first step portion 2211, each stopper 122 is pressed against the second step portion 2212, and each guiding groove 112 is positioned above the inner part of the box body 20.

The water vapor rises and adheres to the inner bottom surface of the cover body 10 after the microwave food is heated. Since the center of the top surface of the convex top portion 11 is higher than the first peripheral wall 111, the water vapor will flow low, allowing the water vapor to flow into the box body 20 along the guiding grooves 12, and the groove 113 and platform portion 221 can prevent the water vapor from flowing out and leaking.

I claim:

1. A water vapor guide cover, comprising:
a cover body, comprising a convex top portion and edge portion, a periphery of said convex top portion configured with a first peripheral wall bended downward, an inner side of said first peripheral wall configured with a plurality of guiding grooves at intervals, a bottom of said first peripheral wall extended outward with a groove, a top of another side of said groove in combination with said edge portion, another side of said edge portion further configured with a second peripheral wall bended downward, and an inner side of said second peripheral wall configured with a plurality of stoppers at intervals; and
a box body, comprising a bottom portion and a third peripheral wall configured on a periphery of said bottom portion, a top surface of said third peripheral wall extended outward with a platform portion, an inner side and outer side of said platform portion respectively configured with a first step portion and second step portion, said edge portion of said cover body in contact with said platform portion, said groove positioned above said first step portion, each said stopper pressed against said second step portion, and each said guiding groove positioned above an inside of said box body.

2. The cover according to claim 1, wherein a center of a top surface of said convex top portion of said cover body is higher than said first peripheral wall.

3. The cover according to claim 1, wherein said first peripheral wall is configured with a plurality of convex arc portions facing inward, said guiding groove positioned between each said two adjacent convex arc portions.

4. The cover according to claim 2, wherein said first peripheral wall is configured with a plurality of convex arc portions facing inward, said guiding groove positioned between each said two adjacent convex arc portions.
